(19) United States
(12) Patent Application Publication
(10) Pub. No.: US 2006/0173896 A1
(43) Pub. Date: Aug. 3, 2006

(54) Authentication method and system for distributing items

(76) Inventors: Geoff Lyon, Menlo Park, CA (US); Salil Pradhan, Santa Clara, CA (US); Bill Serra, Montara, CA (US); Alipio Caban, Arecibo, PR (US); Jorge E. Badillo, Rincon, PR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/048,500

(22) Filed: Jan. 31, 2005

(51) Int. Cl. G06F 17/00

(52) U.S. Cl. 707/102

(57) ABSTRACT

Aspects of the present invention describe a method of introducing items into a distribution network. Before entering items into the distribution network, the item is placed in an identifiable packaging that has an identifier. The identifier associated with the item and packaging is stored in an item identifier database and then the item is distributed into the distribution network. Another aspect of the present invention includes the identification and authentication of the items received from the distribution network. These operations include first receiving the item and corresponding identifier from the distribution network. The identifier associated with the item is read and then cross referenced with the item identifier database. A determination is made whether the identifier associated with the received item matches an entry in item identifier database or not. The item is indicated as authentic when the identifier matches the entry in the item identifier database.

### BACKGROUND OF THE INVENTION

The present invention relates to authentication of items being manufactured and shipped. A great number of products are manufactured in multiple countries around the world. The same product can be manufactured in different countries to take advantage of lower labor costs and overhead in manufacturing as well as proximity to the parties using the products. Currently, the source of manufacture needs to be individually marked on each item to determine the country of origin. This is sometimes difficult or impossible if the items are small or fungible and difficult to write upon or mark. For example, it is difficult to mark pills or other drugs being manufactured around the world as they are too small to mark adequately. Nonetheless, the ingredients or compositions need to be precise and carefully controlled regardless of their origin.

Even if it were possible to mark or label certain items, counterfeiters intentionally introduce many items into commerce with the intent to deceive the users of the product origin or source. These counterfeiters may create legitimate products during the day only to then use the same factories to generate overruns in off-hours for sale in the gray market. Other unauthorized counterfeiters may attempt to pass off items as legitimate however in an attempt to save money or due to inadequate manufacturing capabilities may produce an inferior or sometimes dangerous product.

Counterfeiters are particularly interested in creating counterfeit pharmaceutical products as the profit margins are quite high and it is difficult to identify these products. In the case of pills and other pharmaceuticals, counterfeiters set up business in different countries around the world and then sell the products at lower costs into the same market as the authentic or authorized products. If the chemical compositions are the same, the counterfeit products steal away profits from the companies attempting to recoup their research and development investments in developing the drug. Worse yet, counterfeiters who fail to accurately replicate a drug may induce serious illness or death to those unfortunate enough to take the ersatz drugs.

Conventional approaches for ensuring only authentic items are allowed to enter a market place are difficult to implement and prone to error. For example, many items shipped internationally on ocean freighters in standardized shipping containers are not carefully inspected as it is too time consuming and hard to police. Indeed, the profit associated with counterfeit items is so great that current fines are not a sufficient deterrent. Likewise, random inspections may only capture a few of the counterfeit items and do not dissuade others from continuing this practice.

Consumers, professionals and many businesses currently rely on various imperfect methods of ensuring the products they use are authentic and safe. Unfortunately, if counterfeit or gray market items are not detected in a timely manner the results are often not only financially damaging but, in some cases, dangerous.

### BRIEF DESCRIPTION OF THE DRAWINGS

FIG. 1 is a schematic diagram of a system for identifying an item passing through an item distribution network in accordance with one implementation of the present invention;

FIG. 2 is a flowchart diagram of the operations associated with placing an item into a distribution network in accordance with one implementation of the present invention;

FIG. 3 a flowchart diagram illustrates the operations associated with authenticating an item received over a distribution network in accordance with one implementation of the present invention;

FIG. 4 is a diagram of a scanner device used by one implementation of the present invention to read an identifier from an item; and

FIG. 5 is a schematic diagram of a networked computer system and components used in accordance with one implementation of the present invention.

Like reference numbers and designations in the various drawings indicate like elements.

### SUMMARY OF THE INVENTION

One aspect of the present invention features a method of introducing items into a distribution network. Before entering items into the distribution network, the item is placed in an identifiable packaging that has an identifier. The identifier associated with the item and packaging is stored in an item identifier database and then the item is distributed into the distribution network.

Another aspect of the present invention includes the identification and authentication of the items received from the distribution network. These operations include first receiving the item and corresponding identifier from the distribution network. The identifier associated with the item is read and then cross referenced with the item identifier database. A determination is made whether the identifier associated with the received item matches an entry in item identifier database or not. The item is indicated as authentic when the identifier matches the entry in the item identifier database.

### DETAILED DESCRIPTION

Implementations of the present invention are used to identify items in a distribution network and ensure they are authentic. Each item is scanned for an identifier before introduction into a distribution network. The identifier is placed in an item identifier database for later reference. For example, an RFID identifier associated with a pill or other drug is read by an RFID reader and stored in an Internet accessible database. A store or end user receiving the drug or other item in the distribution network also reads the identifier associated with the item and cross references it to the item identifier database. A chain of custody is produced for the item as it traveled through the distribution network. If the identifier read by store or end user matches the entry in the item identifier database then the item is considered authentic. In a complex distribution network, the chain of custody associated with the item gives details on the different shipping parties involved in transporting the item through the distribution network.

Aspects of the present invention are advantageous in at least one or more of the following ways. Items distributed in the network can be authenticated by a store or end users relatively quickly. The authentication operation involves accessing a database accessible over a network or the Internet and verifying that the identifier is associated with the same item originally submitted into the distribution network. This can be done with very little or small additional costs and modifications to existing computer systems and distribution networks.

Additionally, implementations of the present invention reduce the potential occurrence of damage or harm from poor quality or sub-standard items. In the case of drug counterfeiters, a store can authenticate pills and drugs before selling them or providing them to users. Counterfeit drugs are likely to harm individuals if they are improperly manufactured or have unexpected concentrations of ingredients. Even if the items are authentic, implementations of the present invention can also be used to recall items discovered as being faulty subsequent to the item or drugs introduction into the distribution network.

Many other advantages can also be realized through various implementations of the present invention. Cloned items or drugs can be readily detected when two or more items have already been identified with the same identifier. Further, the present invention can be used to detect when items are being distributed outside of a designated geographic distribution region for the product. For example, unauthorized distribution of drugs or other items can be detected by cross referencing both the identifier associated with the item and the geographic location where the authentication operation is being performed.

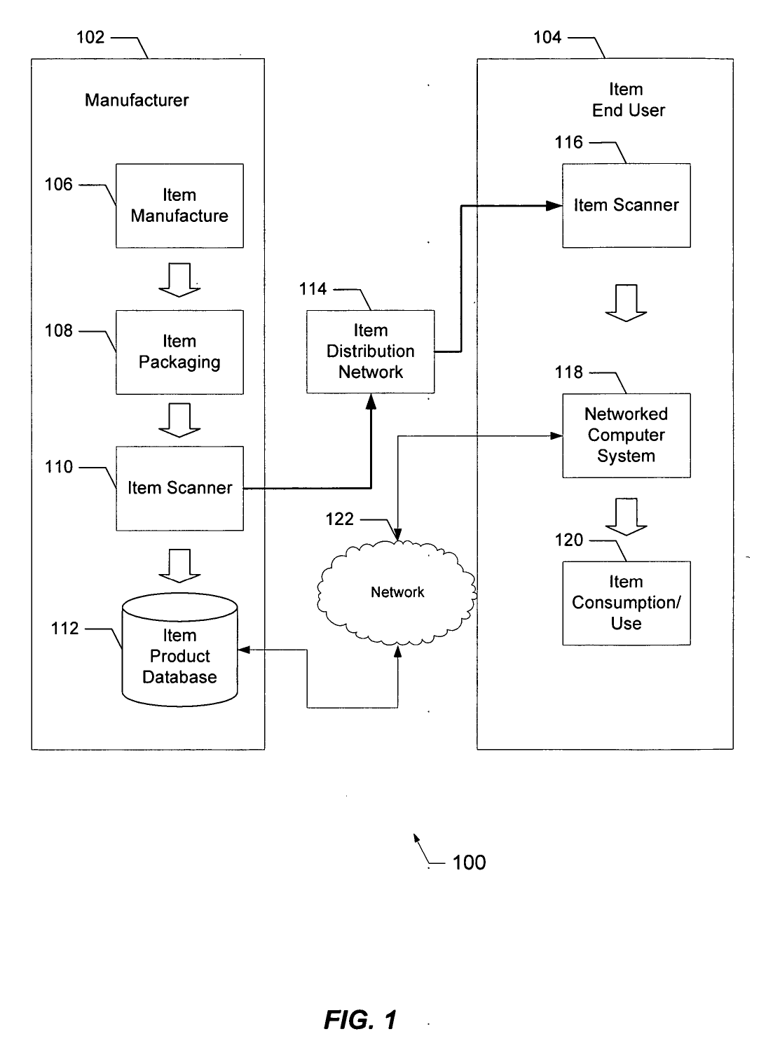

FIG. 1 is a schematic diagram of a system 100 for identifying an item passing over an item distribution network 114. In this illustrated example, system 100 includes an item a manufacturer 102, an item end user 104, an item distribution network 114 for distributing items and a network 122 for identifying the items. In this context, manufacturer 102 can be a business involved in the actual creation or manufacture of the product or item as well as any business that takes existing items and redistributes them in accordance with aspects of the present invention. This includes any third party employed or contracted to perform any one or all of the operations associated with manufacturer 102. Accordingly, manufacturer 102 is a term that not only covers work done by a traditional manufacturer that designs, builds and ships items but also covers any and all work done by any number of parties that may be contracted or employed to perform one or more of these or other related operations. This definition of manufacturer 102 is appropriate as the design, build, and shipment of items are increasingly being outsourced to one or more business especially suited to perform these duties. For example, manufacturer 102 may not necessarily manufacture an item but could be contracted to receive an already manufactured item for packaging and ship it in accordance with implementations of the present invention. Alternatively, it is also contemplated that manufacturer 102 may also receive an item already packaged and then be contracted to only scan the item and distribute it in accordance with implementations of the present invention. There are many other possible combinations that one or more parties operating together could assume to design, build and ship an item in accordance with implementations of the present invention but have been omitted for the sake of brevity.

Likewise, the term ‘end user’ is a descriptive term selected for convenience and includes any company, business, fictitious, or real person that receives an item over item distribution network 114. For example, item end user 104 can represent a drug store receiving drugs over item distribution network 114 as well as a person receiving drugs in the mail or from other common carrier with the desire to accurately identify and/or authenticate the item or drug in accordance with implementations of the present invention.

As one example implementation, manufacturer 102 includes item manufacture 106, item packaging 108, item scanner 110 and an item product database 112. Manufacturer 102 generally is a company or business involved in either the creation of acquisition of an item for sale and/or distribution to item end user 104. Item manufacture 106 in this example therefore includes all the operations needed to manufacture an item as well as those used to acquire the item. In the pharmaceutical industry, item manufacture 106 may include performing research and development, creating drugs resulting from the research and development as well as formulating the drug for use with one or more different drug delivery mechanisms. Alternatively, item manufacture 106 in the pharmaceutical industry may only include formulating generic drugs developed by other companies or simply acquiring drugs created by other companies to then be distributed in accordance with implementations of the present invention.

Item packaging 108 by manufacturer 102 includes ensuring that an item is placed in an identifiable package. In one implementation, this includes attaching an RFID tag, bar-code or other unique identifier on a separate package surrounding the item. For example, placing pills in a small container having an RFID tag attached to the container is one type of item packaging 108. Another type of item packaging 108 includes embedding the RFID tag or other identifier in the item rather than surrounding the item with a packaging having an RFID tag. In the case of drugs, a pill can be embedded with a small RFID tag capable of being safely ingested. A bar code or other type of identification device can also be attached to certain other items if the item is not prohibitively small.

Depending on the type of identifier, item scanner 110 reads the identifier from the item and stores the resulting information in item product database 112. Typically, the identifier is stored in item product database 112 and also cross referenced with other information describing one or more details of the item. The descriptive information is usually visible information readily associated with the item upon inspection. This could include information about the shape, color, weight, dimensions or any other physical attribute of the item including a trade name or technical name of the item. For example, the descriptive information could include the generic or chemical name of a drug as well as a sample picture of the drug, dimensions of the drug and any other visible characteristic associated with the drug. This additional descriptive information helps accurately identify and authenticate an item using system 100.

Item end user 104 in FIG. 1 provides one example illustration of the present invention and includes item scanner 116, networked computer system 118 and item consumption/use 120. Item scanner 116 scans each item delivered over item distribution network 114 in preparation for the identification and/or authentication operations consistent with implementations of the present invention. As previously described, item scanner 116 may include one more different types of sensor for detecting and indicating the identifier associated with the particular item received. For example, item scanner 116 can include one or more sensors associated with RFID scanners, optical scanners, image scanners, bar code scanners and other types of scanners. The identifier retrieved from the item by item scanner 116 is then compared by networked computer system 118 with identifiers and other information in item product database 112. Network 122 used to connect networked computer system 118 and item product database 112 can include a combination of the Internet and an intranet. In one implementation, networked computer system 118 determines if the identifier obtained using item scanner 116 matches an identifier in item product database 112 and also may compare other descriptive information related to the product. Once the item is determined as being authentic or identified, the item proceeds to item consumption/use 120 by the end user. For example, a pharmacist can check the authenticity of drugs being delivered and then dispense the drugs for consumption when implementations of the present invention ensure the authenticity. Over-the-counter (OTC) drugs like aspirin and ibuprofen not dispensed by a pharmacist can be authenticated by people buying the OTC drugs using home based or store based systems designed in accordance with implementations of the present invention.

It should be appreciated that FIG. 1 is a schematic of the manufacturing and packaging operations that may be used in one implementation of the present invention. Additional manufacturing operations, scanning operations and packaging operations may also be required. In addition, the various operations depicted in FIG. 1 may occur in a different order or in conjunction with many other operations not necessarily illustrated in this example that may or may not be related to manufacturing, scanning or packaging.

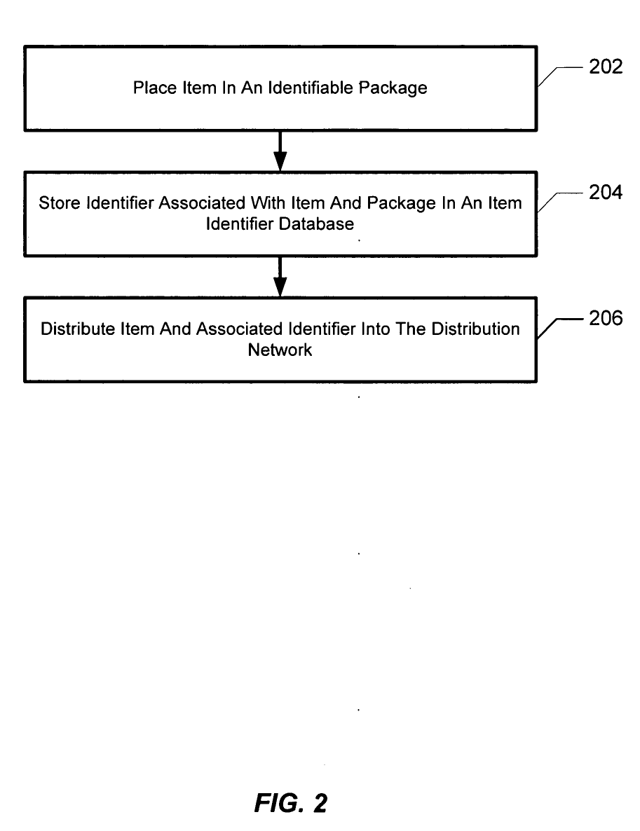

FIG. 2 is a flowchart diagram of the operations associated with placing an item into a distribution network in accordance with one implementation of the present invention. In FIG. 2, a manufacturer places an item in an identifiable package (202). As previously mentioned, this could mean surrounding the item with a container having an identifier or embedding the identifier within the item. For example, one or more pills can be placed in a vial or blister pack having an RFID identifier, a bar code, an alphanumeric identifier imprinted on the package or some other identifier. Each pill could also be individually identified by embedding each pill with an RFID tag and identifier or imprinting the barcode or alphanumeric identifier thereupon. In addition to drugs, implementations of the present invention could be applied to many other items including: medical devices, computer equipment, electronics, luxury items and sports equipment.

Before sending the item into the distribution network, the manufacturer or designated third party then stores the identifier associated with the item and package in an item identifier database (204). If the identifier is known in advance then it is immediately stored in the item identifier database. For example, an alphanumeric number printed on the package or item and known in advance can be stored immediately in the item identifier database. In other cases, the identifier is determined by reading the item and package using one or more scanner devices including: an RFID scanner, an optical scanner, an image scanner and a barcode reader.

Additional information describing the item is also included in the item identifier database for subsequent use later when the identifier is cross referenced with physical characteristics or qualities of the item. This latter descriptive information helps ensure the item is accurately identified and authenticated once it is transmitted through the distribution network. For example, a drug can be described as having a certain color, shape, size, imprinted alphanumeric characters and packaging quantity.

Once the information is collected in the item identifier database, the manufacture then distributes the item and associated identifier into the distribution network (206). The distribution network can be any combination of one or more delivery mechanisms including boats, planes, trucks, trains and common carriers for delivering item. It is contemplated that implementations of the present invention can be used each time an item is transferred between different delivery services or, alternatively, when an item is delivered to a final destination.

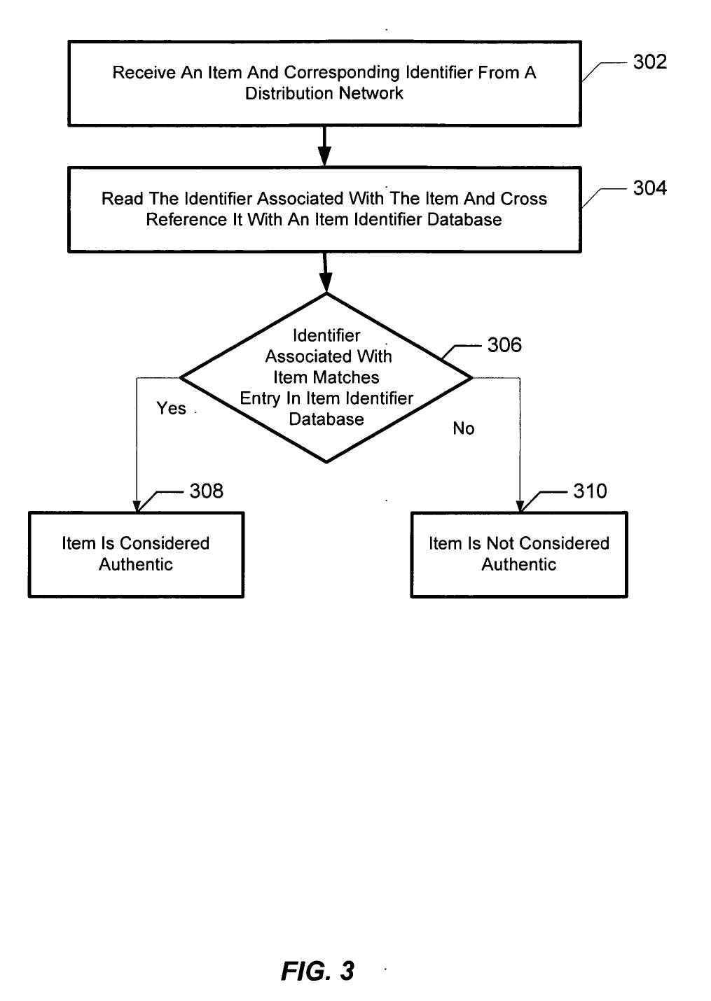

Referring to FIG. 3, a flowchart diagram illustrates the operations associated with authenticating an item received over a distribution network in accordance with one implementation of the present invention. An item end user initially receives the item and corresponding identifier associated with the item from the distribution network (302). As previously mentioned, the item can be anything susceptible to being identified and likely to benefit from identification and authentication in accordance with the present invention. For example, this includes drugs, computer equipment, medical equipment, electronics, luxury items (i.e., expensive purses, gloves, shoes, and accessories), sports equipment and any other item likely to be the target of counterfeiters. Further, the item can be delivered by boat, plane, train, truck or common carrier to any business or person acting as the item end user.

Next, the item end user reads the identifier associated with the item and cross references it with an item identifier database (304). In one implementation, the item end user uses a scanner device to scan and determine the identifier associated with the item. For example, the item end user can use an RFID scanner, an optical scanner, an image scanner and a barcode reader to obtain the identifier from the item. Additionally, the item end user may manually read an alphanumeric value from the item that identifies the particular item. This identifier is then compared with entries in the item identifier database (306) to determine if the item received is from the manufacturer or is a counterfeit item.

An identifier associated with the item that matches an entry in item identifier database generally indicates that the item is authentic (308) and not counterfeit. To be more certain of the authenticity, additional descriptive information concerning the item is also cross referenced in the item identifier database. For example, the color of the item or some other distinguishable characteristic is checked just in case the otherwise valid identifier had been stolen and/or reused. Alternatively, if the identifier associated with the item does not match an entry in the item identifier database then the item is not considered authentic (310).

In addition to indicating the authenticity of an item, implementations of the present invention have many other features and functions. Cloned items or drugs can be readily detected when two or more items have already been identified with the same identifier. Further, the present invention can be used to detect when items are being distributed outside of a designated geographic distribution region for the product. For example, unauthorized distribution of drugs or other items can be detected by cross referencing both the identifier associated with the item and the geographic location where the authentication operation is being performed. Many other uses of the authenticity indicator provided by implementations of the present invention are contemplated.

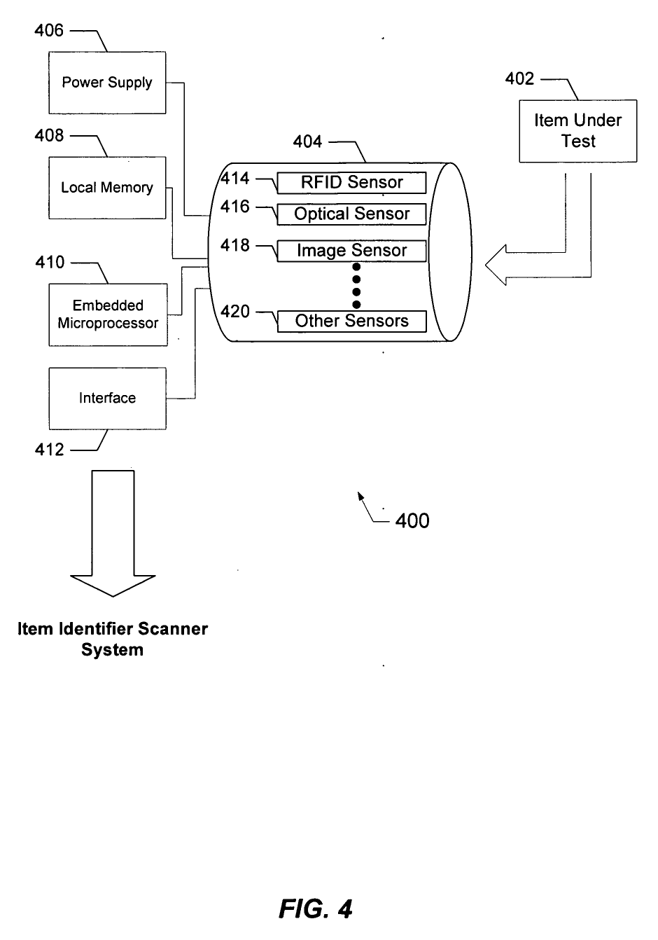

FIG. 4 is a diagram of a scanner device used by one implementation of the present invention to read an identifier from an item. Scanner device 404 includes one or more different scanner technologies as needed to detect one or more identifiers. In this illustrated example, scanner device 404 is equipped with an RFID sensor 414, an optical sensor 416, an image sensor 418 and other sensors 420 as needed. Processing required by each of the one or more sensors is performed by embedded microprocessor 410 and powered by power supply 406. A local memory 408 is provided with scanner 408 to hold intermediary or temporary results as needed by the particular identification and authentication operations as implemented. One authentication method that hashes and encrypts an RFID identifier is described in co-pending U.S. patent application No. XX/XXX,XXX entitled, “AUTHENTICATION METHOD AND SYSTEM FOR RFID TAGGED ITEMS” by Cyril Brignone, Steve Simske, Jorge Badillo, Bill Serra and Guillaume Oget filed Dec. xx, 2004, assigned to the assignee of the present invention and herein incorporated by reference in the entirety.

In operation, item under test 402 is placed in or about scanner device 404 and subjected to one or more sensors as indicated above. These sensors work to detect the identifier associated with item under test 402 and process the resulting information as needed. If the identifier is hashed and/or encrypted, embedded microprocessor 410 may perform one or more preliminary operations to prepare for subsequent operations in accordance with implementations of the present invention. For example, embedded microprocessor 410 may execute code to decrypt an encrypted and hashed identifier stored within memory embedded in item under test 402. Further details of this operation are described in the aforementioned patent application entitled “AUTHENTICATION METHOD AND SYSTEM FOR RFID TAGGED ITEMS”. Once these preliminary results are available, scanner 404 transmits the identifier information through interface 412 to a networked computer system with access to the item identifier scanner system and database.

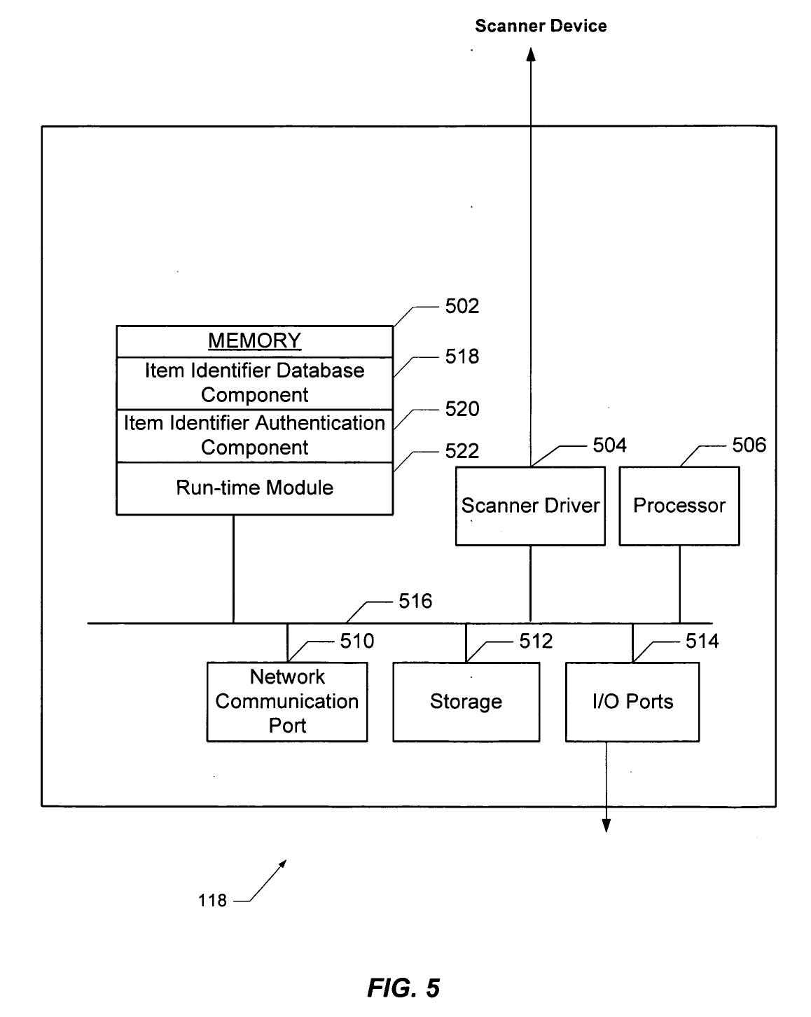

FIG. 5 is a schematic diagram of a networked computer system 118, hereinafter system 118, and components used in accordance with one implementation of the present invention. System 118 includes a memory 502 to hold executing programs (typically random access memory (RAM) or read-only memory (ROM) such as a flash RAM), a scanner driver 504 capable of interfacing to a scanner device designed in accordance with implementations of the present invention, a processor 506, a network communication port 510 for data communication, a storage 512, and input/output (I/O) ports 514 with integrated I/O controller operatively coupled together over an interconnect 516. System 118 can be preprogrammed, in ROM, for example, using field-programmable gate array (FPGA) technology or it can be programmed (and reprogrammed) by loading a program from another source (for example, from a floppy disk, a CD-ROM, or another computer). Also, system 118 can be implemented using customized application specific integrated circuits (ASICs).

In one implementation, memory 502 includes an item identifier database component 518, item identifier authentication component 520, and run-time module 522 that manages the resources associated with system 118. In operation, item identifier database component 518 is capable of accessing an item identifier database over a network or locally to obtain item identifier and related descriptive information as previously described. Authenticity related operations are processed by item identifier authentication component 520. This includes performing any encryption, decryption, hashing, comparison operations or any other functions as required by the particular authentication operations designed in accordance with implementations of the present invention.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

What is claimed is:

1. A method of introducing items into a distribution network, comprising:
placing an item in an identifiable packaging;
storing an identifier associated with the item and packaging in an item identifier database; and
distributing the item and associated identifier into the distribution network.

2. The method of claim 1 wherein the item is selected from a set of items including: a drug, medical devices, computer equipment, luxury items, and sports equipment.

3. The method of claim 1 wherein the identifiable packaging is selected from a set including: an RFID tag embedded in the package, a barcode attached to the packaging and an alphanumeric identifier associated with the packaging.

4. The method of claim 1 wherein the RFID tag embedded in the package is integrated into a drug and can be ingested.

5. The method of claim 1 wherein storing the identifier further comprises scanning the item for the identifier with a reader device selected from a set including: an RFID scanner, an optical scanner, an image scanner and a barcode reader.

6. The method of claim 1 wherein storing the identifier further includes cross referencing the identifier with additional information describing the details of the item.

7. The method of claim 1 wherein distributing the item includes shipping the item to one or more businesses.

8. The method of claim 7 wherein the one or more businesses includes pharmacies, supermarkets, hospitals and medical clinics.

9. The method of claim 7 wherein the shipping is selected from a set including: truck transport, air transport, sea transport and hand-delivered transport.

10. A method of authenticating items received from a distribution network, comprising:
receiving an item and corresponding identifier from the distribution network;
reading the identifier associated with the item and cross reference with an item identifier database;
determining whether the identifier associated with the received item matches an entry in item identifier database; and
receiving an indication that the item is considered authentic when identifier matches the entry in the item identifier database.

11. The method of claim 10 wherein reading the identifier further comprises scanning the item with a reader device selected from a set including: an RFID scanner, an optical scanner, an image scanner and a barcode reader.

12. The method of claim 9 wherein determining whether the identifier matches includes cross referencing descriptive information related to the item in the item identifier database in addition to the identifier.

13. The method of claim 10 further comprising indicating the item has potentially been fraudulently distributed into the distribution network when the item does not match the entry in the item identifier database.

14. The method of claim 10 further comprising indicating the item has been recalled when the item matches the entry in the item identifier database.

15. The method of claim 10 further comprising indicating the item has been cloned when the item is one of two or more items matching the entry in the item identifier database.

16. The method of claim 10 further comprising indicating the item is in an improper distribution area when the item matches the entry in the item identifier database and appears in a geographic region not authorized to receive the item.

17. The method of claim 10 wherein the item is selected from a set of items including: a drug, medical devices, computer equipment, luxury items, and sports equipment.

18. An apparatus for authenticating items to be introduced into a distribution network, comprising:
a processor capable of executing instructions;
a memory for holding instructions when executed on the processor process an item in an identifiable packaging, store an identifier associated with the item and packaging in an item identifier database and distribute the item and associated identifier into the distribution network.

19. The apparatus of claim 18 wherein the item is selected from a set of items including: a drug, medical devices, computer equipment, luxury items, and sports equipment.

20. The apparatus of claim 18 wherein the identifiable packaging is selected from a set including: an RFID tag embedded in the package, a barcode attached to the packaging and an alphanumeric identifier associated with the packaging.

21. The apparatus of claim 20 wherein the RFID tag embedded in the package is integrated into a drug and can be ingested.

22. The apparatus of claim 18 wherein storing the identifier further comprises instructions that scan the item for the identifier with a reader device selected from a set including: an RFID scanner, an optical scanner, an image scanner and a barcode reader.

23. An apparatus for authenticating items received from a distribution network, comprising:
A processor capable of executing instructions;
a memory for holding instructions when executed on the processor receive an item and corresponding identifier from the distribution network, read the identifier associated with the item and cross reference with an item identifier database, determine whether the identifier associated with the received item matches an entry in item identifier database and receive an indication that the item is considered authentic when identifier matches the entry in the item identifier database.

24. The apparatus of claim 23 wherein reading the identifier further comprises instructions that scan the item with a reader device selected from a set including: an RFID scanner, an optical scanner, an image scanner and a barcode reader.

25. The apparatus of claim 23 further comprising instructions that indicate the item is in an improper distribution area when the item matches the entry in the item identifier database and appears in a geographic region not authorized to receive the item.

26. The apparatus of claim 23 wherein the item is selected from a set of items including: a drug, medical devices, computer equipment, luxury items, and sports equipment.

27. A method of authenticating items received from a distribution network, comprising:
receiving an identifier from the distribution network corresponding to an item;
cross referencing the identifier associated with the item using an item identifier database;
determining whether the identifier associated with the received item matches an entry in item identifier database; and
providing an indication that the item is considered authentic when the identifier matches the entry in the item identifier database.

28. The method of claim 27 wherein the identifier received was scanned using a reader device selected from a set including: an RFID scanner, an optical scanner, an image scanner and a barcode reader.

29. The method of claim 27 further comprising indicating the item has potentially been fraudulently distributed into the distribution network when the item does not match the entry in the item identifier database.

30. The method of claim 27 wherein the item is selected from a set of items including: a drug, medical devices, computer equipment, luxury items, and sports equipment.
